(19) United States
(12) Patent Application Publication
(10) Pub. No.: US 2021/0102145 A1
(43) Pub. Date: Apr. 8, 2021

(54) FORMULATION FOR CLEANING HARD SURFACES

(71) Applicant: GPCP IP Holdings LLC, Atlanta, GA (US)

(72) Inventors: Andrew Paul Balliet, Appleton, WI (US); Chimene Theresa Halfmann, Ripon, WI (US); Jeffrey Charles Duhacek, Neenah, WI (US); Mary Grace Glesner, Columbia, SC (US)

(21) Appl. No.: 15/733,067

(22) PCT Filed: Nov. 6, 2018
(86) PCT No.: PCT/US18/59453

§ 371 Date: May 6, 2020

Related U.S. Application Data
(60) Provisional application No. 62/588,894, filed on Nov. 20, 2017.
(60) Provisional application No. 62/582,036, filed on Nov. 6, 2017.

(51) Int. Cl. C11D 3/37; C11D 3/12; C11D 1/72; C11D 11/00; C11D 17/04; C11D 3/43; C11D 3/34

(52) U.S. Cl. CPC C11D 3/3765; C11D 3/1253; C11D 1/72; C11D 3/3481; C11D 17/049; C11D 3/43; C11D 11/0023

(57) ABSTRACT

A formulation for cleaning hard surfaces, such as floors, is provided. The cleaning solution includes a film forming composition, e.g., comprising a polymer or particles, which can form a uniform protective coating as a residue on the hard surface. The cleaning formulation further includes at least one non-ionic surfactant and at least one solvent.

### 1. REFERENCE TO RELATED APPLICATIONS

This application claims priority to U.S. Provisional Application Ser. No. 62/582,036, filed Nov. 6, 2017, and U.S. Provisional Application Ser. No. 62/588,894, filed Nov. 20, 2017, the contents of which are hereby incorporated by reference in their entireties.

### 2. FIELD OF THE INVENTION

A formulation for cleaning floors and other hard surfaces is provided. More particularly, the cleaning formulation includes a film forming composition, which can comprise a polymer or particles, e.g., clay or polymeric particles, suspended in a solvent with a surfactant, which forms a uniform coating on the hard surface.

### 3. BACKGROUND OF THE INVENTION

Liquid cleaning solutions are used for a variety of uses, including for personal, commercial, and industrial cleaning applications. Such cleaning solutions can remove dirt, dust, soil, grease, oils, and the like from surfaces. Cleaning solutions can either be applied as a ready-to-use or diluted prior to use. Additionally, they can be sprayed or otherwise applied directly to the surface, or can be carried on a substrate, such as a wet wipe or mop head.

During cleaning, a portion of the solution can remain on the surface, even when a substrate is used in the cleaning. Generally, cleaning solutions primarily include water, solvents, and surfactants of various ionic nature, which evaporate from the surface to varying degrees. Accordingly, such cleaning solutions do not provide an ongoing protection for the surface which can quickly accumulate new soil.

Thus, there remains a need in the art for cleaning formulations that are effective at removing soil from a surface, while coating the surface to resist and release further soil from the surface. The presently disclosed subject matter addresses these and other needs.

### 4. SUMMARY

The presently disclosed subject matter provides for a cleaning formulation containing specific components, which advantageously deposits a uniform protective coating on the surface that is cleaned.

Specifically, the cleaning formulation includes a film forming composition, at least one non-ionic surfactant, and at least one solvent. The cleaning formulation exhibits unexpected resistance to greasy and oily soils when applied to the surface and it is believed that the particles in the cleaning formulation can form a polymeric network on a surface and provide a barrier to prevent further dirt, dust, soil, grease, oils, and the like from adhering to the surface. Thus, further instances of soil can be easily released from the surface by removing the particles from the surface.

As embodied herein, the film forming composition can include particles. In certain embodiments, the particles can comprise polymeric and/or clay particles. For example, and not limitation, the particles comprise clay particles based on sodium and/or magnesium silicate. In certain embodiments, the clay particles can comprise Laponite™ SL 25, Laponite™ S482, and/or Laponite™ RD. Alternatively, the film forming composition can comprise a polymer, such as an acrylic polymer emulsion. For example, the film forming composition can be present in an amount of from about 0.001 wt-% to about 50 wt-%, based on the overall weight of the cleaning formulation. Furthermore, in certain embodiments, the non-ionic surfactant can comprise a linear alcohol ethoxylate. For example, the non-ionic surfactant can comprise Undeceth-3 and/or C₉₋₁₁Pareth-8. In certain embodiments, the non-ionic surfactant can be present in an amount of from about 0.001 wt-% to about 30 wt-%, based on the overall weight of the cleaning formulation.

As embodied herein, the solvent can comprise a glycol ether. For example, the cleaning formulation can comprise propylene glycol n butyl ether and/or dipropylene glycol n-butyl ether. In certain embodiments, the solvent can be present in an amount of from about 0.001 wt-% to about 5 wt-%, based on the overall weight of the cleaning formulation.

In certain embodiments, the cleaning formulation can further include one or more additional components. For example, and not limitation, such additional components can be selected from hydrotropes, defoamers, preservatives, fragrances, and combinations thereof. As embodied herein, the hydrotrope can comprise sodium xylene sulfonate. For example, the hydrotrope can be present in an amount of from about 0.01 wt-% to about 10 wt-%, based on the overall weight of the cleaning formulation. If present, the defoamer can comprise emulsified silicone. For example, the defoamer can be present in an amount of from about 0.001 wt-% to about 10 wt-%, based on the overall weight of the cleaning formulation. Similarly, if present, the preservative can comprise a combination of methylisothiazolone and octylisothiazolone. For example, the preservative can be present in an amount of from about 0.001 wt-% to about 2 wt-%, based on the overall weight of the cleaning formulation. If present, and for example, the fragrance can be present in an amount of from about 0.001 wt-% to about 5 wt-%, based on the overall weight of the cleaning formulation.

In certain aspects, the present disclosure further provides a wipe comprising a cleaning formulation including a film forming composition, a non-ionic surfactant, and solvent. The present disclosure further provides methods of cleaning a hard surface using such a cleaning formulation and/or wipe.

The foregoing has outlined broadly the features and technical advantages of the present application in order that the detailed description that follows may be better understood. Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 5. DETAILED DESCRIPTION

The presently disclosed subject matter provides a formulation for cleaning hard surfaces, such as floors. The cleaning solution includes a film forming composition, which can form a uniform protective coating as a residue on the hard surface. For example, in certain embodiments, the film forming composition can include a polymer. In other embodiments, the film forming composition can include particles, e.g., clay or polymeric particles. The cleaning formulation further includes at least one non-ionic surfactant and at least one solvent. The present disclosure further provides methods of cleaning a surface with such a cleaning formulation and cleaning products including such formulations. The present disclosure additionally provides methods of cleaning soils from various surfaces with such a cleaning formulation and cleaning products including such formulations, for example, in pet care applications. These and other aspects of the disclosed subject matter are discussed more in the detailed description and examples.

### Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value.

As used herein, the term “weight percent” is meant to refer to the quantity by weight of a constituent/component in the cleaning formulation as a percentage of the overall weight of the cleaning formulation. The terms “weight percent”, “wt-%”, and “wt%” are used interchangeably.

As used herein, a “nonwoven” refers to a class of material, including but not limited to textiles or plastics. Nonwovens are sheet or web structures made of fiber, filaments, molten plastic, or plastic films bonded together mechanically, thermally, or chemically. A nonwoven is a fabric made directly from a web of fiber, without the yarn preparation necessary for weaving or knitting. In a nonwoven, the assembly of fibers is held together by one or more of the following: (1) by mechanical interlocking in a random web or mat; (2) by fusing of the fibers, as in the case of thermoplastic fibers; or (3) by bonding with a cementing medium such as a natural or synthetic resin.

### Cleaning Formulations

The present disclosure provides cleaning formulations, which can be suitable for cleaning hard surfaces such as floors, countertops, and the like. Such cleaning formulations can also be suitable for cleaning soils from various surfaces, for example, in pet care applications. As embodied herein, the cleaning formulations include a film forming composition, which form a uniform coating on the surface being cleaned. This coating can form a film across the surface and can protect the surface from being soiled. For example, the film forming composition can spread across the surface to create a contiguous layer comprising a polymer or particles. For example, in embodiments with particles, the particles within the film forming composition can penetrate dents, scratches, seams, and other etches on the surface and, in certain embodiments, can have a higher concentration of particles in these areas to smooth the overall appearance of the surface. For further example, in certain embodiments with polymers, the polymers can spread to form a visibly continuous layer on the surface being cleaned. The film forming composition can be carried in a solvent, and deposited evenly as a film when the solvent dries. The film forming properties of the solvent can be aided by the selection of particular solvents and/or non-ionic surfactants for use in the cleaning formulations.

In this manner, the film forming composition can remain in place after cleaning and is believed to form a polymeric network that acts as a protective uniform coating. Thus, the cleaning formulations of the present disclosure advantageously and unexpectedly impart protective properties to unavoidable residue that remains on the surface after cleaning. For example, in embodiments with particles, the remaining particles are believed to interfere with the adhesion of further soils to the surface. That is, any new instances of soil (e.g., grease, dirt, dust, oil, etc.) are believed to preferentially adhere to the particles rather than the surface. Accordingly, this new soil can be easily released from the surface upon subsequent cleanings by carrying the particles away from the surface using a solvent (e.g., by reapplying the same cleaning formulation). For further example, in embodiments with a polymer film forming composition, the polymer can form a hard film on the surface to act as a barrier against further dirt and provide a visually appealing glossy coating to the surface. As embodied herein, the layer of film, whether containing a polymer or particles, can prevent the surface from being wetted by further instances of a moist soil.

As such and as embodied herein, the present disclosure provides a cleaning formulation comprising a film forming composition. In certain embodiments, the film forming composition can comprise a polymer, e.g., an acrylic polymer emulsion. In other embodiments, the film forming composition can comprise particles, e.g., with sodium and/or magnesium silicates such as Laponite® (available from BYK-Chemie GmbH, Wesel, Germany). In particular embodiments, it was surprisingly and advantageously found that including Laponite® as an active agent in the film forming composition of cleaning formulations of the present disclosure provides for both the effective removal of soils from a surface and uniform coating of the surface to resist and release further soil. In other embodiments, the film forming composition can comprise a fatty acid, such as a tall oil fatty acid. The cleaning formulation further includes at least one surfactant, which can act as a superwetter, and at least one solvent. In certain embodiments, the cleaning formulation can optionally include one or more additional components, including, but not limited to, a hydrotrope, defoamer, preservative, and/or fragrance. As described in greater detail below, the cleaning formulation can be suitable for being carried on and released by a substrate, such as a nonwoven material.

The cleaning formulation can be an aqueous or non-aqueous solution. In certain embodiments, the cleaning formulation is an aqueous solution. The cleaning formulation can have any suitable pH range from about 1 to about 14. For example, and not limitation, the pH of the cleaning formulation can range from about 6 to about 13, and preferably, from about 8 to about 13.

### Particles

The particles for use in the film forming compositions of the presently disclosed cleaning formulations can be any particle suitable for forming a polymeric network on a hard surface. In certain embodiments, the particles can comprise a polymer and/or a clay mineral.

In particular embodiments, the particles can be in solid form. For example, in certain embodiments, the particles can be in a powder form. In certain embodiments, the particles can be nanoparticles. In alternative embodiments, the particles can be in a salve form.

For example and not limitation, the particles can comprise clay minerals selected from sodium, lithium, magnesium, and/or aluminum silicates. The particles can be synthetic or natural clay minerals. For example, in certain embodiments, the clay minerals can be materials of the mineral classes of smectites, kaolinites, illites, chlorites, or attapulgites, and/or can be montmorillonite, bentonite, pyrophyllite, hectorite, saponite, sauconite, nontronite, talc, beidellite, volchonskoite, vermiculite, kaolinite, dickite, antigorite, anauxite, indellite, chrysotile, bravaisite, suscovite, paragonite, biotite, corrensite, penninite, donbassite, sudoite, pennine, sepiolite, or polygorskyte. Further details regarding clay minerals and their use as particles can be found in U.S. Pat. Nos. 9,194,078 and 9,657,436; U.S. Patent Publication Nos. US2010/0215894A1, US2016/0298288A1, and US2017/0030010A1; and International Patent Publication Nos. WO2014/059415A1 and WO2014/059413A1, the contents of which are hereby incorporated by reference in their entireties. In particular embodiments, the particles can comprise Laponite® (available from BYK-Chemie GmbH, Wesel, Germany). Laponite® can have unique viscosity building characteristics and has thixotropic properties based on its mechanical sheer and coating properties. Laponite® can be typically used as an emulsion stabilizer, a rheology modifier, and/or as anti-stats. As embodied herein, Laponite® can be used as an active agent such as a sacrificial soil-release agent or an anti-soiling agent in cleaning formulations. It was surprisingly and advantageously found that cleaning formulations disclosed herein including a film forming composition including Laponite® nanoparticles as an active agent provided for increased resistance to soils and a uniform protective coating when applied to a surface. Thus, the inclusion of Laponite® nanoparticles as a sacrificial soil-release agent or an anti-soiling agent in cleaning formulations disclosed herein provide for both the effective removal of soils from a surface and uniform coating of the surface to resist and release further soil. Laponite® is available in various grades, including RD, RDS, SL-25, JS, 5482, B, S, XLS, XLG, XL21, D, DF, DS, HW, EL, OG, LV and EP, with various functional groups. In particular embodiments, the particles comprise Laponite® SL-25 or Laponite® S482. In other particular embodiments, the particles comprise Laponite® RD.

As embodied herein, the particles can be present in the cleaning formulation in an amount of from about 0.001 wt-% to about 50 wt-%, or from about 0.002 wt-% to about 25 wt-%, or from about 0.005 wt-% to about 10 wt-%, or from about 0.01 wt-% to about 5.0 wt-%, or from about 0.02 wt-% to about 2.0 wt-%, based on the overall weight of the cleaning formulation. In alternative embodiments, the particles can be present in the cleaning formulation in an amount of from about 0.001 wt-% to about 95 wt-%, or from about 0.001 wt-% to about 90 wt.-%, or from about 0.001 wt-% to about 80 wt-%, or from about 0.001 wt-% to about 70 wt.-%, or from about 0.001 wt-% to about 60 wt.-%, based on the overall weight of the cleaning formulation.

### Polymers

As embodied herein, the presently disclosed film forming compositions for use in cleaning formulations can include polymers. Such polymers can be present in the form of particles (i.e., polymeric particles) or the polymers can be in the form of emulsions or another configuration. When the polymers are used as an emulsion, they can be dissolved in the solvent of the cleaning formulation, as described in greater detail below. A person of ordinary skill in the art will appreciate that a neutralizer, e.g., a basic salt such as ammonium hydroxide (e.g., Aqua Ammonia 29% available from Fisher Scientific, Waltham, Mass.), can be used in the cleaning formulation to enhance the solubility of the polymer.

For example, and not limitation, suitable polymers include acrylic emulsions (e.g., EPS® 2799, EPS® 2570 and/or EPS® 2538, available from Engineered Polymer Solutions & Color Corporation of America, Marengo, Ill.), polyurethane acrylic emulsions (e.g., Noverite™ 100, available from The Lubrizol Corporation, Wickliffe, OH), and latexes (e.g., Dermacryl® E, available from AkzoNobel N.V., Amsterdam, Netherlands). In particular embodiments, the polymer is an acrylic emulsion, such as EPS® 2799, or a styrenated acrylic emulsion, such as EPS® 2538 or EPS® 2570.

As embodied herein, the polymer can be present in the cleaning formulation in an amount of from about 0.001 wt-% to about 50 wt-%, or from about 0.01 wt-% to about 25 wt-%, or from about 0.1 wt-% to about 20 wt-%, or from about 0.5 wt-% to about 10 wt-%, based on the overall weight of the cleaning formulation.

### Non-Ionic Surfactants

The presently disclosed cleaning formulation can further comprise one or more non-ionic surfactants. As embodied herein, the non-ionic surfactant can provide a cleaning function and can also modify the drying rate and surface tension of the cleaning formulation to ensure that that the resulting coating comprising the polymeric particles is uniformly deposited. In certain embodiments, the non-ionic surfactant can act as a wetting agent or superwetter additive. As used herein, “superwetter” refers to a surfactant that can reduce the equilibrium surface tension of water to less than about 30 dynes/cm, e.g., from about 20 dynes/cm to about 25 dynes/cm. In contrast, other surfactants generally reduce the surface tension of water to from about 30 dynes/cm to about 35 dynes/cm.

A person of ordinary skill will appreciate that any suitable non-ionic surfactant can be used in the presently disclosed cleaning formulations, including, but not limited to linear alcohol ethoxylates (LAEs) (such as C₉₋₁₁Pareth-3, C₉₋₁₁Pareth-6, C₉₋₁₁Pareth-8, Undeceth-3, Undeceth-5, Undeceth-7, Undeceth-9, C₁₂₋₁₃ Pareth-3, C₁₂₋₁₃ Pareth-7, C₁₂₋₁₅ Pareth-3, C₁₂₋₁₃ Pareth-7, and C₁₂₋₁₅ Pareth-9), secondary alcohol ethoxylates (e.g., C₁₂₋₁₄; 7-40 moles of ethylene oxide (EO)), branched secondary alcohol ethoxylates (including alpha-[3,5-dimethyl-1-(2-methylpropyl)hexyll-omega-hydroxy-Poly(oxy-1,2-ethanediyl)], also known as Tergitol TMN, available from The Dow Chemical Company, Midland, Mich.), nonylphenol ethoxylates (including nonylphenol polyethylene glycol ether (e.g., 4-70 moles EO)), octylphenol ethoxylates (including polyethylene glycol octylphenyl ether (4.5-55 moles EO)), ethoxylated and propoxylated copolymers (such as 2-ethyl hexanol EO-PO, CAS No. 64366-70-7), alkyl polyglucosides (such as decyl/undecyl glucosides, lauryl glucosides, butyl glucosides, caprylyl/capryl glucosides, methyl glucosides, C₈₋₁₄ alkyl polyglucosides, and cocoglucosides), and/or PEG 14 dimethicone. In particular embodiments, at least two non-ionic surfactants can be present in the cleaning formulation. For example, and not limitation, the cleaning formulation can include two or more linear alcohol ethoxylates, such as Undeceth-3 (e.g., BIO-SOFT® N1-3, available from Stepan Company, Northfield, Ill.) and C₉₋₁₁Pareth-8 (e.g., BIO-SOFT® N91-8, available from Stepan Company, Northfield, Ill.). Additionally or alternatively, the cleaning formulation can include PEG 14 dimethicone (e.g., ABIL® B 8843, available from Evonik Industries AG, Essen, Germany).

As embodied herein, the non-ionic surfactant, or each non-ionic surfactant if two or more are present, can be used in the cleaning formulation in an amount of from about 0.001 wt-% to about 30 wt-%, or from about 0.002 wt-% to about 25 wt-%, or from about 0.003 wt-% to about 20 wt-%, or from about 0.005 wt-% to about 15 wt-%, or from about 0.005 wt-% to about 10 wt-%, or from about 0.01 wt-% to about 5.0 wt-%, or from about 0.02 wt-% to about 2.0 wt-%.

### Solvents

As embodied herein, the presently disclosed cleaning solutions can include one or more solvents. The solvents can carry the film forming composition and wholly or partly evaporate upon application to a hard surface, to leave behind a uniform film, e.g., comprising the polymer or particles. The solvents can also act to dissolve any dirt, grease, or oil on the surface. Additionally, the use of a low volatility solvent can cause the film forming composition to coalesce on the surface. A person of skill in the art will appreciate that a solvent can be selected with a volatility suitable for use in the cleaning of hard surfaces, e.g., that does not evaporate under the conditions of storage, but readily evaporates upon application to the surface.

By way of example, and not limitation, suitable solvents include ethanol, methanol, butanol, acetone, isopropyl alcohol, propylene glycol, propanediol, ethylene glycol, butylene glycol, triethylene glycol, diethylene glycol, dibasic esters, and glycol ethers, such as, but not limited to, dipropylene glycol methyl ether, dipropylene glycol n-butyl ether, dipropylene glycol n-propyl ether, propylene glycol diacetate, propylene glycol methyl ether, propylene glycol n-butyl ether, propylene glycol n-propyl ether, propylene glycol phenyl ether, tripropylene glycol methyl ether, tripropylene glycol n-butyl ether, tripropylene glycol n-butyl ether, and dipropylene glycol dimethyl ether. In certain embodiments, the solvent can comprise one or more glycol ethers. For example, in particular embodiments, the solvent can comprise propylene glycol n-butyl ether (such as Dowanol PNB, available from The Dow Chemical Company, Midland, Mich.) and/or dipropylene glycol n-butyl ether (such as Dowanol DPNB, available from The Dow Chemical Company, Midland, Mich.). In certain embodiments, two or more solvents are present. For example, and not limitation, the cleaning formulation can comprise both of propylene glycol n-butyl ether and dipropylene glycol n-butyl ether. In certain embodiments, three or more solvents are present. For example, and not limitation, the cleaning formulation can comprise propylene glycol, propylene glycol n-butyl ether and dipropylene glycol n-butyl ether.

As embodied herein, the one or more solvents can be present in the cleaning formulation in an amount of from about 0.001 wt-% to about 5 wt-%, or from about 0.005 wt-% to about 3 wt-%, or from about 0.01 wt-% to about 2 wt-%, or from about 0.05 wt-% to about 1.5 wt-%, based on the overall weight of the cleaning formulation.

### Additional Components

The presently disclosed cleaning formulation can further include one or more additional components. In certain embodiments, the cleaning formulation can include one or more of a hydrotrope, a defoamer, a preservative, a fragrance, and combinations thereof. However, a person of skill in the art will appreciate that various components, e.g., those commonly used in the art in cleaning solutions, can also be present.

In certain embodiments, the cleaning formulation includes a hydrotrope. The hydrotrope can help to keep hydrophobic components in the cleaning formulation in solution. For example, the hydrotrope can maintain the solubility of alcoholic solvents, such as glycol ether, and accordingly, with the surfactant, can ensure that the components remain in solution. In certain embodiments, the hydrotrope can boost the activity of the non-ionic surfactant because the non-ionic surfactant has more capacity to perform a cleaning function. As embodied herein, the hydrotrope can be present in an amount of from about 0.01 wt-% to about 10 wt-%, or from about 0.01 wt-% to about 5 wt-%, or from about 0.01 wt-% to about 2 wt-%, or from about 0.02 wt-% to about 1 wt-%, or from about 0.05 wt-% to about 0.4 wt-%, based on the overall weight of the cleaning formulation.

The hydrotrope can be any suitable hydrotrope, as is known in the art. For example, and not limitation, the hydrotrope can be cumene sulfonate, toluene sulfonate, xylene sulfonate, alkanoate, caprylyl sulfonate, alkyl naphthalene sulfonate, and/or alkyl benzene sulfonate, and/or a salt therefore. For example, the hydrotrope can be an ammonium, sodium, or potassium salt of any of the afore-listed compounds. In particular embodiments, the hydrotrope is sodium xylene sulfonate (e.g., Naxonate® 4LS, available from Nease Co., LLC, Cincinnati, Ohio).

Additionally or alternatively, in certain embodiments, the cleaning formulation can include a defoamer, or anti-foaming agent. As embodied herein, the defoamer can be present in an amount of from about 0.001 wt-% to about 10 wt-%, or from about 0.005 wt-% to about 5 wt-%, or from about 0.01 wt-% to about 2 wt-%, or from about 0.01 wt-% to about 1 wt-%, or from about 0.02 wt-% to about 0.4 wt-%, based on the overall weight of the cleaning formulation. Examples of suitable defoamers include, but are not limited to, those based on silicone, mineral oil, polyoxyethene stearyl ether, and polyethylene glycol and polypropylene glycol copolymers (EO/PO based defoamers). In particular embodiments, the defoamer can include an emulsified silicone defoamer (e.g., BYK-024, available from BYK-Chemie GmbH, Wesel, Germany). In other particular embodiments, the defoamer can include polyoxyethene stearyl ether (e.g., TEGO® Foamex 7447, available from Evonik Industries AG, Essen, Germany).

Furthermore, in certain embodiments, the cleaning formulation can include one or more preservatives. The preservative can be present in an amount of from about 0.001 wt-% to about 2 wt-%, based on the overall weight of the cleaning formulation, depending on the preservative used. Any suitable preservative can be incorporated into the cleaning formulation, including, but not limited to, methylisothiazolinone, benzoisothiazolinone, methylchloroisothiazolinone, octylisothiazolinone, phenoxyethanol, caprylyl glycol, parabens (such as methylparaben, ethylparaben, propylparaben, butyl paraben, isobutylparaben, isopropylparaben, benzylparaben, or their sodium salts), butylated hydroxytoluene, dehydroacetic acid, benzoic acid (or a salt thereof, such as sodium benzoate), formaldehyde releasers (e.g., quaternum-15), imidazolindinyl urea, diazolindnyl urea, DMDM hydantoin, 2-bromo-2-nitropropane-1,3-diol, 5-bromo-5-nitro-1,3-dioxane, tris(hydroxymethyl nitromethane, and combinations thereof. In particular embodiments, the preservative can comprise a combination of methylisothiazolone and octylisothiazolone (e.g., BIOBANTM 425, available from The Dow Chemical Company, Midland, Mich.). In such embodiments, the preservative can be present in an amount of from about 0.02 wt-% to about 0.1 wt-%, based on the overall weight of the cleaning formulation. In other particular embodiments, the preservative can comprise a combination of phenoxyethanol and caprylyl glycol (e.g., Optiphen™ preservatives, available from Ashland Inc., Covington, Ky.). In such embodiments, the preservative can be present in an amount of from about 0.01 wt-% to about 1.0 wt-%, based on the overall weight of the cleaning formulation.

In certain embodiments, the cleaning formulation can include a neutralizer in order to promote the solubility of one or more components in the cleaning formulation. For example, the neutralizer can solubilize one or more polymers in the cleaning formulation. Suitable neutralizers include, but are not limited to, ammonium hydroxide and potassium hydroxide. The neutralizers can be added in an amount suitable to solubilize one or more components in the cleaning formulation, e.g., in an amount of less than about 2.0 wt-%, or less than about 1.0 wt-%, or less than about 0.5 wt-%, based on the overall weight of the cleaning formulation.

Additionally or alternatively, the cleaning formulation can include a fragrance. The use of a fragrance can enhance the consumer experience by masking the scents of other chemicals and imparting a clean scent to the hard surface being cleaned. The fragrance can be present in an amount of from about 0.001 wt-% to about 5 wt-%, or from about 0.002 wt-% to about 2 wt-%, or from about 0.005 wt-% to about 1 wt-%, or from about 0.008 wt-% to about 0.5 wt-%, or from about 0.01 wt-% to about 0.1 wt-%, based on the overall weight of the cleaning formulation. In particular embodiments, and not by way of limitation, the fragrance can comprise Symrise Sunshine Herbs #737173, Symrise Clear Springs #997597, Symrise #380423, or Symrise #997598 (all available from Symrise AG, Holzminden, Germany), although a person of skill in the art will appreciate that a wide variety of fragrances are suitable for use in the cleaning formulations of the present disclosure.

### Applications

The presently disclosed cleaning formulations can be used in a wide variety of applications, and can be suitable for cleaning hard surfaces, including wood, granite, marble, tile, ceramic, plaster, metal, and plastic surfaces. In particular embodiments, the presently disclosed cleaning formulations can be suitable for use in pet care applications (e.g., for use with pet care wipes). For example, such cleaning formulations can be used alone or in combination with a pet care wipe for cleaning of pet-related soils, such as urine, feces, or vomit from various surfaces. As embodied herein, the cleaning formulations can be used as a liquid solution for direct application to the surface being cleaned, e.g., by spraying or otherwise applying the cleaning formulation directly onto the surface. Alternatively, the cleaning formulations can be disposed on a substrate, such as a foam, textile, or nonwoven substrate, for application to the surface. For example, the cleaning formulations can be disposed on a wet wipe or a pet care wipe. In further embodiments, the cleaning formulations can be concentrated. For example, the cleaning formulation can be concentrated up to 10 times, based on the amounts (e.g., weight percentages) disclosed herein. Cleaning formulations of the present disclosure provide for the safe removal of dirt and grime resulting in a thorough and easy clean. Additionally, such formulations protect from stuck-on grime. An all-in-one solution also allows for quick, easy, and thorough cleaning.

In particular embodiments, cleaning formulations of the present disclosure can be applied as ready-to-use formulations without the need for dilution (e.g., with water) prior to use. In certain embodiments, such cleaning formulations can include an increased amount of particles (e.g., clay particles) as compared to cleaning formulations requiring such pre-use dilution.

The particles of the cleaning formulations can provide a uniform coating to the hard surface. As embodied herein, the coating can be present across the surface in a contiguous layer, including in any dents, scratches, etches, seams, etc. in the surface.

The aqueous solution can emulsify and suspend to existing soils that reside on the surface, enabling for the removal of the soils from the substrate with a paper towel, cloth, wipe, or sponge, including greasy or oily stains and soils, such as shoe polish, lipstick, oil pastels, and oily dirt, and thereby provide a substrate that can be readily or more easily removed from the surface. Alternatively, the coating can exhibit unexpected resistance to greasy and/or oily soils when applied to the surface. For example, in embodiments with particles, it is believed that the particles in the coating can adhere to new soil that is introduced to the surface, and thereby provide a barrier to prevent such soil from adhering to the surface. In either embodiment, the soil can be easily released from the surface by collecting and removing the particles from the surface. Additionally, the presently disclosed cleaning formulations can impart a glossy appearance to the surface upon drying. In addition to greasy or oily stains, cleaning formulations of the present disclosure can also enable the removal of aqueous and non-aqueous soils. Such cleaning formulations can provide for the removal of bodily soils such as urine, feces, or vomit from various surfaces.

The efficacy of the cleaning formulation can be observed by treating a surface with the cleaning formulation, then applying a soil to the surface (or waiting for soil to accumulate) and cleaning it again. The amount of soil remaining after cleaning the surface can be visually observed and/or picked up and measured with an electrostatic substrate (e.g., a microfiber cloth). Additionally, the suitability of the consistency, volatility, and glossiness of the cleaning formulation for a surface can be observed using various draw down tests. The glossiness of the applied cleaning formulation can also be directly measured, e.g., using a glossmeter.

### 6. EXAMPLES

The following examples are merely illustrative of the presently disclosed subject matter and they should not be considered as limiting the scope of the subject matter in any way.

### Example 1

The present Example provides for cleaning formulations suitable for use in cleaning hard surfaces. The cleaning formulations included clay particles (with silicic acid, lithium magnesium sodium salt and (1-hydroxyethylidene) bisphosphonic acid, sodium salt), two non-ionic surfactants (Undeceth-3 and C₉₋₁₁ Pareth-8), and two solvents (propylene glycol n-butyl ether and dipropylene glycol n-butyl ether). The cleaning formulations further included a hydrotrope (sodium xylene sulfonate), a defoamer (polysiloxane silicone in polypropylene glycol), a preservative (a combination of 2-methyl-4-isothiazolin-3-one and 2-n-octyl-4-isothiazolin-3-one), and a fragrance. The balance of the cleaning formulations comprised purified (reverse osmosis) water.

The cleaning formulations were prepared with various concentrations of the active ingredients—as Formulations 1A-1D—for use in various end uses. Formulation 1A was formulated for use with a nonwoven material in a wet wipe product. Formulation 1B was formulated at a ready-to-use concentration as a hard surface cleaner, e.g., as a spray. Formulation 1C was formulated as a concentrate and Formulation 1D was formulated as a super concentrate. The compositions of Formulations 1A-1D are provided in Table 1, below.

TABLE 1

| | | Formulation (wt-%, as delivered) | | | |
|---|---|---|---|---|---|
| Raw Material | CAS No. | 1A | 1B | 1C | 1D |
| RO Water | N/A | 97.96% | 97.99% | 80.26% | 3.46% |
| Sodium xylene sulfonate | 1300-72-7 | 0.10% | 0.10% | 1.00% | 5.00% |
| Undeceth-3 | 34398-01-1 | 0.10% | 0.10% | 1.00% | 5.00% |
| C₉₋₁₁ Pareth-8 | 68439-46-3 | 0.12% | 0.12% | 1.20% | 6.00% |
| Polysiloxane silicone in | N/A | 0.10% | 0.10% | 1.00% | 5.00% |
| polypropylene glycol | | | | | |
| Propylene glycol n-butyl ether | 5131-66-8 | 0.30% | 0.30% | 3.00% | 15.00% |
| Dipropylene glycol n-butylether | 29911-28-2 | 0.20% | 0.20% | 2.00% | 10.00% |
| Silicic acid, lithium magnesium | 53320-86-8 | 1.00% | 1.00% | 10.00% | 50.00% |
| sodium salt | | | | | |
| (1-hydroxyethylidene) | 29329-71-3 | | | | |
| bisphosphonic acid, sodium salt | | | | | |
| 2-methyl-4-isothiazolin-3-one | 2682-20-4 | 0.07% | 0.04% | 0.04% | 0.04% |
| 2-n-octyl-4-isothiazolin-3-one | 26530-20-1 | | | | |
| Fragrance | N/A | 0.05% | 0.05% | 0.50% | 0.50% |

### Example 2

The present Example provides for additional cleaning formulations suitable for use in cleaning hard surfaces. The various cleaning formulations included different film forming compositions, based on one or more acrylic polymer emulsions and/or clay particles (with one or both of silicic acid, lithium magnesium sodium salt and (1-hydroxyethylidene) bisphosphonic acid, sodium salt). One formulation (Formulation 2E) included tall oil fatty acids instead of a polymer or particles; this formulation further included the neutralizer potassium hydroxide to provide solubility to the fatty acids. Additionally, some formulations including polymers included ammonium hydroxide as a neutralizer to improve solubility. The cleaning formulations further included one or more of three non-ionic surfactants (Undeceth-3, C₉₋₁₁ Pareth-8, and PEG 14 dimethicone) and one or both of two solvents (propylene glycol n-butyl ether and dipropylene glycol n-butyl ether). Some cleaning formulations also included a hydrotrope (sodium xylene sulfonate), a defoamer (polysiloxane silicone in polypropylene glycol or a mixture of siloxane polymer and polyoxyethene stearyl ether), and a preservative (a combination of 2-methyl-4-isothiazolin-3-one and 2-n-octyl-4-isothiazolin-3-one). The balance of the cleaning formulations comprised purified (reverse osmosis) water.

TABLE 2

| | | | Formulation (wt-%, as delivered) | | | | | | | | | | | |
|---|---|---|---|---|---|---|---|---|---|---|---|---|---|---|
| Raw Material | CAS No. | 2A | 2B | 2C | 2D | 2E | 2F | 2G | 2H | 2I | 2J | 2K | 2L | 2M |
| RO Water | N/A | 96.67 | 94.59 | 95.64 | 89.24 | 99.39 | 92.51 | 88.35 | 77.95 | 78.93 | 93.55 | 90.86 | 83.55 | 90.55 |
| Acrylic polymer | | 2.00 | 4.00 | — | — | — | 6.00 | 10.00 | 20.00 | — | 5.00 | 5.69 | 5.00 | 5.00 |
| emulsion | | | | | | | | | | | | | | |
| Ammonium | 1336-21-6 | 0.08 | 0.16 | — | — | — | 0.24 | 0.40 | 0.80 | — | 0.20 | 0.20 | 0.20 | 0.20 |
| Hydroxide 29% | | | | | | | | | | | | | | |
| Styrenated acrylic | | — | — | 4.00 | 10.00 | — | — | — | — | 20.01 | — | — | — | — |
| polymer emulsion | | | | | | | | | | | | | | |
| C₉₋₁₁Pareth-8 | 68439-46-3 | 0.12 | 0.12 | — | — | — | 0.12 | 0.12 | 0.12 | — | 0.12 | 0.12 | 0.12 | 0.12 |
| Undeceth-3 | 34398-01-1 | 0.10 | 0.10 | 0.06 | 0.06 | — | 0.10 | 0.10 | 0.10 | 0.10 | 0.10 | 0.10 | 0.10 | 0.10 |
| Sodium xylene | 1300-72-7 | 0.10 | 0.10 | — | — | — | 0.10 | 0.10 | 0.10 | — | 0.10 | 0.10 | 0.10 | 0.10 |
| sulfonate | | | | | | | | | | | | | | |
| PEG 14 | 68937-54-2 | — | — | 0.05 | 0.10 | — | — | — | — | — | — | — | — | — |
| dimethicone | | | | | | | | | | | | | | |
| Propylene glycol n- | 5131-66-8 | 0.41 | 0.41 | — | — | 0.20 | 0.41 | 0.41 | 0.41 | 0.41 | 0.41 | 0.41 | 0.41 | 0.41 |
| butyl ether | | | | | | | | | | | | | | |
| Dipropylene glycol | 29911-28-2 | 0.40 | 0.40 | 0.24 | 0.60 | 0.10 | 0.40 | 0.40 | 0.40 | 0.40 | 0.40 | 0.40 | 0.40 | 0.40 |
| n-butylether | | | | | | | | | | | | | | |
| Polysiloxane | N/A | 0.05 | 0.05 | — | — | — | 0.05 | 0.05 | 0.05 | — | 0.05 | 0.05 | 0.05 | 0.05 |
| silicone in | | | | | | | | | | | | | | |
| polypropylene | | | | | | | | | | | | | | |
| glycol | | | | | | | | | | | | | | |
| 2-methyl-4- | 2682-20-4 | 0.07 | 0.07 | — | — | — | 0.07 | 0.07 | 0.07 | 0.06 | 0.07 | 0.07 | 0.07 | 0.07 |
| isothiazolin-3-one | | | | | | | | | | | | | | |
| 2-n-octy1-4- | 26530-20-1 | | | | | | | | | | | | | |
| isothiazolin-3-one | | | | | | | | | | | | | | |
| Tall oil fatty acids | 61790-12-3 | — | — | — | — | 0.20 | — | — | — | — | — | — | — | — |
| Potassium | 1310-58-3 | — | — | — | — | 0.11 | — | — | — | — | — | — | — | — |
| hydroxide | | | | | | | | | | | | | | |
| Polyoxyethene | 9005-00-9 | — | — | — | — | — | — | — | — | 0.10 | — | — | — | — |
| stearyl ether | | | | | | | | | | | | | | |
| Siloxane polymer | N/A | | | | | | | | | | | | | |
| Silicic acid, lithium | 53320-86-8 | — | — | — | — | — | — | — | — | — | — | 2.00 | — | — |
| magnesium sodium | | | | | | | | | | | | | | |
| salt | | | | | | | | | | | | | | |
| Silicic acid, lithium | 53320-86-8 | — | — | — | — | — | — | — | — | — | — | — | 10.00 | 3.00 |
| magnesium sodium | | | | | | | | | | | | | | |
| salt | | | | | | | | | | | | | | |
| (1-hydroxy | 29329-71-3 | | | | | | | | | | | | | |
| ethylidene) | | | | | | | | | | | | | | |
| bisphosphonic | | | | | | | | | | | | | | |
| acid, sodium salt | | | | | | | | | | | | | | |

To test the glossiness of various formulations, 4 of the formulations (Formulations 2B and 2F-2H) were wiped on an engineered hardwood substrate and allowed to dry in 5 layers. Each formulation was wiped onto a natural (non-etched) surface and an etched surface. The treated and untreated sides of each substrate were measured using a BYK Sphere Glossmeter (BYK, Wesel, Germany) with a D65 illuminant. For each formulation, two readings were averaged and, if the surface was uneven, multiple regions were captured and recorded separately. The gloss values for each formulation on each side of the substrate are provided in Table 3.

TABLE 3

| | Etched Surface | | Non-Etched Surface | |
|---|---|---|---|---|
| Formulation | Untreated | Treated | Untreated | Treated |
| 2B | 7 | 15 | 25 | 45 |
| 2F | 6 | 32 | 25 | 46 |
| 2G | 9 | 63 | 25 | 70 |
| 2H | 9 | 46 | 24 | 65 |

As shown in Table 3, as the amount of acrylic polymer emulsions increased from 4.0 wt-% to 20 wt-% within the cleaning formulation, the glossiness of the coating increased, on both the etched and non-etched surface as compared to the untreated surfaces. Accordingly, the use of a film forming composition comprising a polymer was able to impart glossiness, e.g., by increasing the glossiness value by 20 or more units, to both smooth and etched surfaces following product application.

### Example 3

The present Example provides for additional cleaning formulations suitable for use in cleaning hard surfaces. Such cleaning formulations are also suitable for use in pet care applications (e.g., alone or disposed on a pet care wipe). The cleaning formulation (Formulation 3A) included clay particles (with silicic acid, lithium magnesium sodium salt and (1-hydroxyethylidene) bisphosphonic acid, sodium salt), two non-ionic surfactants (Undeceth-3 and C9-11 Pareth-8), and three solvents (propylene glycol, propylene glycol n-butyl ether, and dipropylene glycol n-butyl ether). Additionally, the formulation included a polymer (styrenated acrylic polymer emulsion), a neutralizer to improve solubility of the polymer (ammonium hydroxide), a hydrotrope (sodium xylene sulfonate) and a preservative (a combination of methylisothailazolinone and octylisothailazolinone). The balance of the cleaning formulation comprised deionized water.

TABLE 4

| | | Formulation |
|---|---|---|
| | | (wt-%, as delivered) |
| Raw Material | Tradename | 3A |
| Deionized Water | N/A | 88.05 |
| Silicic acid, | Laponite ™ SL-25 | 4.54 |
| lithium magnesium | | |
| sodium salt and | | |
| 1-hydroxyethylidene | | |
| bisphosphonic acid, | | |
| sodium salt | | |
| Styrenated acrylic | EPS 2570 | 6.00 |
| polymer emulsion | | |
| Ammonium | Aqua Ammonia 29% | 0.02 |
| Hydroxide 29% | | |
| Sodium xylene | Naxonate ® 4LS | 0.04 |
| sulfonate | | |
| C₉₋₁₁ Pareth-8 | BIO-SOFT ® N91-8 | 0.12 |
| Undeceth-3 | BIO-SOFT ® N1-3 | 0.10 |
| Propylene glycol | Dowanol PNB | 0.02 |
| n-butyl ether | | |
| Dipropylene glycol | Dowanol DPNB | 0.04 |
| n-butyl ether | | |
| Propylene Glycol | Propylene Glycol, | 1.00 |
| | Industrial Grade | |
| methylisothailazolinone, | BIOBAN ™ 425 | 0.07 |
| octylisothailazolinone | | |

Formulation 3A was tested for glossiness and was wiped on an engineered hardwood substrate and allowed to dry. The formulation provided for a relatively hard coating with a satin-like finish. The addition of clay particles provided additional film thickness to the coating. The coating also filled in seams of the substrate and prevented liquids from penetrating the seams. It is believed such formulations would provide similar soil release properties as formulations without clay particles.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

What is claimed is:

1. A cleaning formulation for providing a uniform coating to a hard surface, comprising:
a film forming composition in an amount of from about 0.001 wt-% to about 50 wt-%, based on the overall weight of the cleaning formulation, wherein the particles comprise polymeric and/or clay particles;
at least one non-ionic surfactant in an amount of from about 0.001 wt % to about 30 wt-%, based on the overall weight of the cleaning formulation; and
at least one solvent.

2. (canceled)

3. (canceled)

4. The cleaning formulation of claim 1, wherein the particles comprise clay particles based on sodium and/or magnesium silicate.

5. The cleaning formulation of claim 4, wherein the clay particles comprise Laponite™ SL-25, Laponite™ S482, or Laponite™ RD.

6. The cleaning formulation of claim 1, wherein the film forming composition comprises a polymer.

7. The cleaning formulation of claim 6, wherein the polymer comprises an acrylic polymer emulsion.

8. (canceled)

9. The cleaning formulation of claim 1, wherein the non-ionic surfactant comprises a linear alcohol ethoxylate.

10. The cleaning formulation of claim 9, wherein the non-ionic surfactant comprises Undeceth-3 and/or C₉₋₁₁Pareth-8.

11. (canceled)

12. The cleaning formulation of claim 1, wherein the solvent comprises a glycol ether.

13. The cleaning formulation of claim 12, wherein the solvent comprises propylene glycol n-butyl ether and/or dipropylene glycol n-butyl ether.

14. (canceled)

15. The cleaning formulation of claim 1, further comprising at least one additional component selected from the group consisting of hydrotropes, defoamers, preservatives, fragrances, and combinations thereof.

16. The cleaning formulation of claim 15, wherein the hydrotrope comprises sodium xylene sulfonate.

17. The cleaning formulation of claim 15, wherein the hydrotrope is present in an amount of from about 0.01 wt-% to about 10 wt-%, based on the overall weight of the cleaning formulation.

18. The cleaning formulation of claim 15, wherein the defoamer comprises emulsified silicone.

19. The cleaning formulation of claim 15, wherein the defoamer is present in an amount of from about 0.001 wt-% to about 10 wt-%, based on the overall weight of the cleaning formulation.

20. The cleaning formulation of claim 15, wherein the preservative comprises a combination of methylisothiazolone and octylisothiazolone.

21. The cleaning formulation of claim 15, wherein the preservative is present in an amount of from about 0.001 wt-% to about 2 wt-%, based on the overall weight of the cleaning formulation.

22. The cleaning formulation of claim 15, wherein the fragrance is present in an amount of from about 0.001 wt-% to about 5 wt-%, based on the overall weight of the cleaning formulation.

23. A wipe, comprising the cleaning formulation of claim 1.

24. A method of cleaning a hard surface, comprising applying the cleaning formulation of claim 1 to the hard surface.

25. A cleaning formulation for providing a uniform coating to a hard surface, the cleaning composition comprising:
a film forming composition in an amount of from about 0.001 wt-% to about 50 wt-%, based on the overall weight of the cleaning formulation, wherein the particles comprise polymeric and/or clay particles;
at least one non-ionic surfactant in an amount of from about 0.001 wt % to about 30 wt-%, based on the overall weight of the cleaning formulation;
optionally, at least one additional component selected from the group consisting of hydrotropes in an amount of from about 0.01 wt-% to about 10 wt-%, based on the overall weight of the cleaning formulation, defoamers in an amount of from about 0.001 wt-% to about 10 wt-%, based on the overall weight of the cleaning formulation, preservatives in an amount of from about 0.001 wt-% to about 2 wt-%, based on the overall weight of the cleaning formulation, fragrances in an amount of from about 0.001 wt-% to about 5 wt-%, based on the overall weight of the cleaning formulation, and combinations thereof; and
at least one solvent.
